(19) United States
(12) Patent Application Publication
(10) Pub. No.: US 2025/0311684 A1
(43) Pub. Date: Oct. 9, 2025

(54) MULTI-ZONE IRRIGATION SYSTEM WITH ANIMAL DETERRENT CAPABILITY

(71) Applicant: Gregg H. Ledesma, East Islip, NY (US)

(72) Inventor: Gregg H. Ledesma, East Islip, NY (US)

(21) Appl. No.: 19/171,655

(22) Filed: Apr. 7, 2025

Related U.S. Application Data
(60) Provisional application No. 63/631,781, filed on Apr. 9, 2024.

(51) Int. Cl. A01G 25/16; A01M 29/00

(52) U.S. Cl. CPC A01G 25/16; A01M 29/00

(57) ABSTRACT

An irrigation system having animal deterrent capability includes an irrigation system controller having an irrigation switching circuit, which selectively provides a water valve energizing voltage on an output thereof. A water valve connected to a water source is electrically coupled to the irrigation switching circuit output, and allows water to flow out of a water outlet thereof in response to the water valve energizing voltage being provided on the irrigation switching circuit output. A water sprinkler receives water from the water valve. A motion detector transmits a detection signal in response to detected motion of an object. A detection signal receiver receives the detection signal and includes a bypass switching circuit, which selectively provides the water valve energizing voltage to the water valve in response to the detection signal.

### CROSS-REFERENCE TO RELATED APPLICATIONS

This application is related to U.S. Provisional Application Ser. No. 63/631,781, filed on Apr. 9, 2024, and titled “Animal Deterrent Apparatus”, the disclosure of which is incorporated herein by reference and on which priority is hereby claimed.

### BACKGROUND OF THE INVENTION

### Field of the Invention

The present invention generally relates to irrigation and sprinkler systems and apparatus and a method of deterring animals from entering certain areas, and more particularly relates to an automatic animal detection and water deterrent system.

### Description of the Prior Art

Private and commercial agricultural markets such as gardens, nurseries and marketable crop fields are constantly hindered by the intrusion of wildlife in the area and the inadvertent devastation that they cause. Very often animals such as deer, rabbits, and even domestic animals such as cats, dogs and horses, intrude onto fields of product and feed or trample on the plants and flowers therein. Such damages may ruin gardens and fields and ultimately undermine the availability of food and limit economic commerce.

Conventionally, gardens and fields have been contained by fences, but such method has been proven to be both expensive and only semi-efficient at best. Fencing may deter larger animals but requires constant maintenance. Additionally, fencing a large area can place a significant burden on the owner. Many farmers have resorted to more lethal options of deterring animals such as firearms and traps. However, even the lethal options require constant funding and oversight to be effective.

Private homeowners also find the intrusion of animals onto their property as being an annoyance. Deer, in particular, seem to savor the taste of flowers and certain plants and shrubbery, and of course homegrown vegetables and fruit, to the detriment of the hard work of homeowners in planting and caring for such plantings.

### OBJECTS AND SUMMARY OF THE INVENTION

It is an object of the present invention to provide a multi-zone irrigation system having the capability to deter animals in a humane, non-lethal way from agricultural markets, private residences and recreational facilities.

In accordance with one form of the present invention, an irrigation system having animal deterrent capability includes an irrigation system controller. The irrigation system controller has at least one irrigation switching circuit. The at least one irrigation switching circuit has an input on which is provided a water valve energizing voltage and an output, and selectively provides the water valve energizing voltage on the output thereof.

The irrigation system of the present invention, in one form, further includes at least one water valve. The at least one water valve has a water inlet and a water outlet. The water inlet is in fluid communication with a source of water. The at least one water valve is electrically coupled to the output of the at least one irrigation switching circuit. The at least one water valve allows water to flow therethrough from the water inlet to and out of the water outlet in response to the water valve energizing voltage being provided on the output of the at least one irrigation switching circuit of the irrigation system controller.

The irrigation system of the present invention, in one form, further includes at least one water sprinkler. The at least one water sprinkler is in fluid communication with the water outlet of the at least one water valve. The at least one water sprinkler receives water flowing out of the water outlet of the at least one water valve.

The irrigation system of the present invention, in one form, further includes at least one motion detector. The at least one motion detector has a zone of motion detection associated therewith and transmits a detection signal either wirelessly or through electrical wires in response to motion of an object being detected in the zone of motion detection.

The irrigation system of the present invention, in one form, further includes a detection signal receiver. The detection signal receiver receives the detection signal transmitted either wirelessly or through electrical wires by the at least one motion detector. The detection signal receiver has at least one bypass switching circuit. The at least one bypass switching circuit has an input on which is provided the water valve energizing voltage and an output, and selectively providing the water valve energizing voltage on the output thereof in response to the detection signal transmitted by the at least one motion detector.

The at least one water valve is further electrically coupled to the output of the at least one bypass switching circuit of the detection signal receiver. The at least one water valve allows water to flow therethrough from the water inlet to and out of the water outlet in response to the water valve energizing voltage being provided on the output of the at least one bypass switching circuit of the detection signal receiver.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is an illustration of a multi-zone irrigation system having animal deterrent capability formed in accordance with the present invention.

FIG. 2 is a block diagram of a multi-zone irrigation system having animal deterrent capability formed in accordance with the present invention.

FIG. 3 is a schematic diagram of a multi-zone irrigation system having animal deterrent capability formed in accordance with the present invention.

### DETAILED DESCRIPTION OF THE PREFERRED EMBODIMENTS

The present invention provides an irrigation system 2, preferably situated underground, having the capability to deter animals from intruding into sensitive agricultural and recreational areas. In accordance with one form of the present invention, the irrigation system 2 may include an automatic detection system that detects the presence of an animal and energizes the irrigation system 2 to spray water at a location where the animal is detected.

The detection system may include a motion sensing device 18 such as an infrared detector. In a preferred form, the detection system includes a wireless, self powered passive infrared (PIR) detector 18, the PIR detector 18 being in frequency communication with a wireless receiver 24. The PIR detector 18 may be positioned in a specific zone to detect the heat signature of a trespassing animal. When the PIR detector 18 senses the presence of an animal, a corresponding signal 22 is transmitted to the wireless receiver 24. The wireless receiver 24 may then engage the activation system connected thereto to energize the irrigation system 2.

The irrigation system 2 may be in the form of an underground irrigation system or may be an independent sprinkler system operating independently of the underground irrigation system 2. The irrigation system 2 may include a single zone or a plurality of zones, each zone being activated by a solenoid water valve 10. A main water line is connected to a water supply, the main water line being constantly pressurized from the water supply. The main water line may branch into a plurality of zone water lines, each zone water line being coupled to the main water line by a solenoid water valve 10. The solenoid water valve 10 may be selectively engaged and disengaged by a sprinkler control unit 4 to pressurize and depressurize each of the zone water lines, respectively. Each zone water line may have one or more sprinkler heads 16 coupled thereto. The control unit 4 may selectively turn on a specific zone water line or a plurality of zone water lines based upon time, date or other programmable factors, creating a scheduled sprinkling pattern.

The wireless receiver 24 of the detection system may be connected to the solenoid water valve 10 of the irrigation system 2 by an internal output relay 26 within the receiver 24. The connection to the solenoid water valve 10 is preferably in parallel with a relay or switching circuit 6 of the sprinkler control unit 4 so as to allow both the existing sprinkler control unit 4 and wireless receiver 24 to activate a zone water line and sprinkler heads 16 attached thereto.

Alternatively, or in combination, an independent water spray system comprising a main water line connected to a water supply may be installed. Similar to an underground irrigation system 2, the independent system may include a plurality of zone water lines coupled to the main water line by the solenoids of a plurality of water valves 10. The wireless receiver 24 may be connected to the solenoid water valves 10 of the independent system to selectively energize and de-energize, that is, pressurize and depressurize, a zone water line. The wireless receiver 24 may be programmed to energize the solenoid water valve 10 momentarily, in duration, or until the PIR detector 18 no longer senses the animal heat signature.

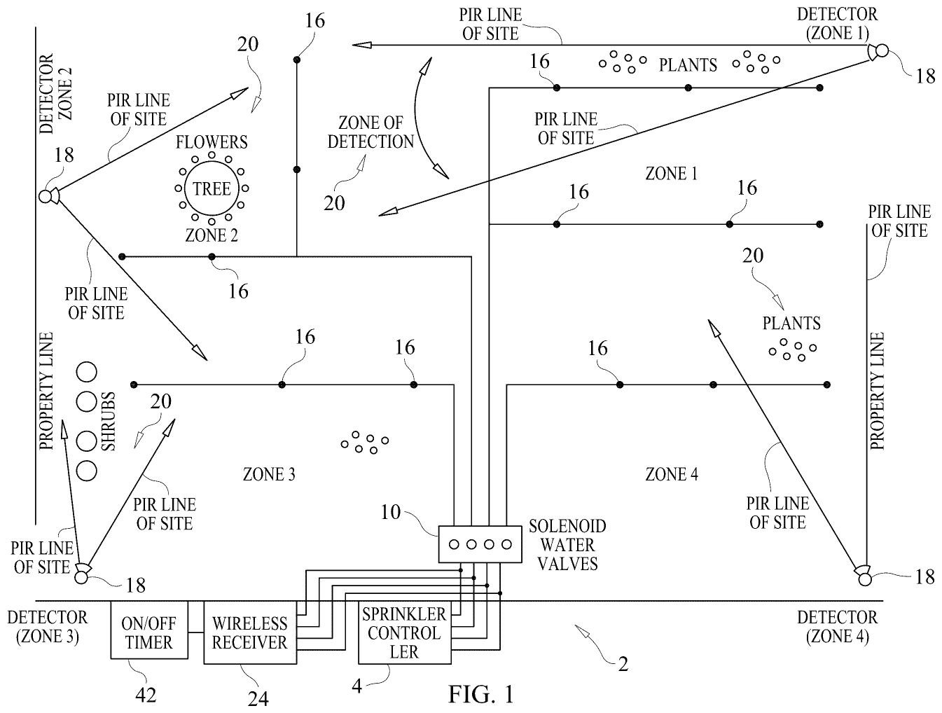

Referring initially to FIG. 1 of the drawings, it will be seen that a four zone detection and water spray (or irrigation) system 2 formed in accordance with the present invention for deterring and/or repelling intruding animals from an owner's property includes a plurality of PIR detectors 18 that are positioned with their angle (zone) of detection 20 encompassing shrubs, flowers, trees or plants which are desired by the property owner to be protected. When one of the PIR detectors 18 senses the heat of an animal within its angle of detection 20, it sends out a wireless signal 22 to a wireless receiver 24. The wireless receiver 24 is powered through an on/off timer 42 that preferably shuts off power to the wireless receiver 24 during times when normal irrigation occurs (and the irrigation or sprinkler system 2 is already on). The wireless receiver 24 includes a plurality of relays 26 which then provide power to the solenoid water valves 10 of the irrigation or sprinkler system 2 independently of the power provided by the sprinkler controller 4 of the irrigation system 2 to the solenoid water valves 10. In other words, the relays 26 of the wireless receiver 24 are preferably connected in parallel with the corresponding zone relays or switching circuits 6 of the sprinkler controller 4 that provides power selectively to each zone of the irrigation system 2. As stated previously, there may be one or more sprinkler heads 16 on each zone which are controlled by the solenoid water valves 10 of the irrigation system 2.

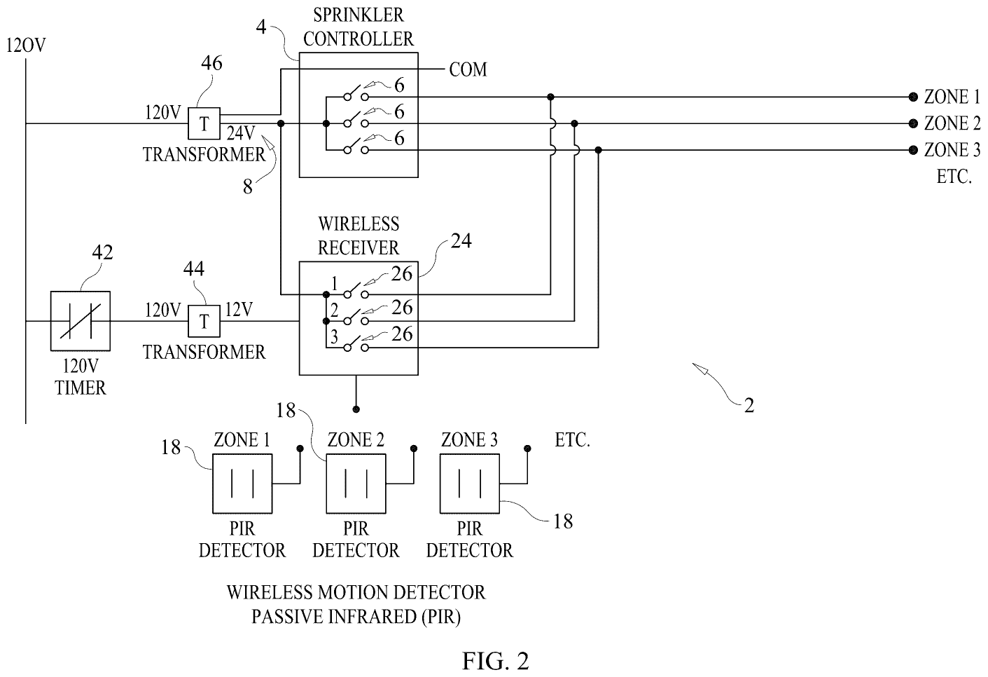

FIG. 2 of the drawings illustrates in block diagram form the preferred form of the present invention. As can be seen from FIG. 2, the sprinkler or irrigation system 2 is connected to house power (120 volts AC) through a transformer 46, which reduces the house voltage to 24 volts AC. The lower power voltage (also referred to herein as the water valve energizing voltage) 8 is provided to the sprinkler controller 4, which is programmed by the user to turn on various switching circuits 6 or relays therein (shown simply as single pole, single throw switches to facilitate an understanding of the invention), which can selectively provide power to the water control solenoid of a water valve 10 of the particular irrigation zone forming part of the irrigation system 2 of the present invention.

There is preferably one wireless motion detector 18 (preferably a passive infrared (PIR) detector) for each zone. The PIR detector 18 transmits a signal wirelessly to the wireless receiver 24 of the detection system preferably forming part of the irrigation system 2.

The wireless receiver 24 is powered through a timer 42 that is connected to 120 volts AC that is connected to a transformer or power circuit 44 to reduce the power to the wireless receiver 24 to 12 volts (preferably, DC). The wireless receiver 24 includes a plurality of relays or other switching circuits 26, shown in FIG. 2 as simply single pole, single throw switches for simplicity, each relay 26 being provided to control energizing voltage 8 to a respective solenoid water valve 10 of the irrigation system 2. One input contact of each relay circuit 26 is connected to 24 volts 8 from the transformer 46 for the sprinkler controller 4. The other contact of each relay circuit 26 is connected to a respective solenoid water valve 10 for a particular zone of the irrigation system 2, so that the relays or switching circuits 6 of the sprinkler controller 4 are essentially connected in parallel with the relays or switching circuits 26 of the wireless receiver 24. In this way, either the sprinkler controller 4, when energized, or the wireless receiver 24, when energized, can provide energizing power 8 to a respective water control valve 10 of the irrigation system 2, which controls the sprinklers 16 of a particular zone of the irrigation system 2.

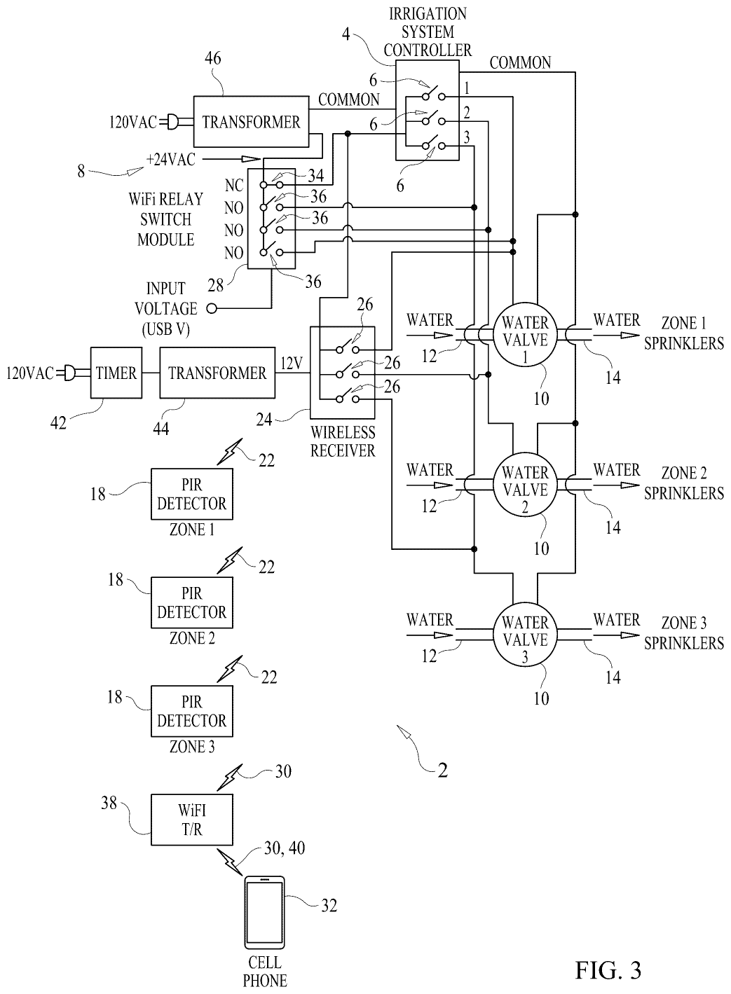

FIG. 3 is a more detailed schematic diagram representing the preferred form of the irrigation system 2 of the present invention and its interconnected circuitry to selectively effect animal deterrence. As can be seen from FIG. 3, power is provided to a transformer 46 of the irrigation system 2, which provides 24 volts AC (the water valve energizing voltage 8) to the programmable water sprinkler controller 4 of the irrigation system 2. The water sprinkler controller 4 has a common electrical connection to each of the water valves 10 in the irrigation system 2, and individual voltage signal lines (24 volts AC, for example) from the outputs of the relay switching circuits 6 of the controller 4 to each of the water control valves 10 of the irrigation system 2.

The wireless receiver 24 is powered with a 12 volt transformer or power circuit 44, which is connected to 120 volts AC through a conventional timer 42. The timer 42 is optionally provided so that the wireless receiver 24 may be disabled during times when the water sprinkler system 2 is operational or at certain times of the day.

The wireless receiver 24, as mentioned previously, includes a plurality of switching circuits or relays 26 (shown as single pole, single throw switches), the input contacts of which are connected preferably to the 24 volt AC valve energizing power 8 of the sprinkler system 2 provided by the sprinkler system's transformer 46. The output contact of each relay switching circuit 26 is connected to the 24 volt line side of a respective water control valve 10 for a particular zone of the irrigation system 2.

The PIR detector 18, when an intruding animal is sensed, sends a detection signal 22 out to the wireless receiver 24, which receives the signal 22 and turns on a particular relay or switching circuit 26 of the wireless detection signal receiver 24 corresponding to the particular zone in which the PIR detector 18 is positioned. The relay or switching circuit 26 which is activated in the wireless receiver 24 then provides the 24 volt valve energizing voltage 8 to the water valve 10 of that particular zone to turn on the sprinklers 16 of that particular zone where the animal was detected, to repel the animal from that zone.

Not all zones of the irrigation system 2 need be controlled by the wireless PIR detectors 18. Only the zones near the perimeter of the property need be controlled to deter animals from intruding across the property line; internal zones of the irrigation system 2 need not be controlled by the detection circuitry of the present invention, although it is envisioned to be within the scope of the present invention to do so.

The irrigation system 2 of the present invention or, in particular, the animal intrusion portion thereof, may include circuitry which allows the system 2 to be controlled using an app on a cell phone or other smart device 32. More specifically, and as shown in FIG. 3, a cell phone 32 can transmit a signal 40 to a WiFi transmitter/receiver 38, which in turn transmits an override signal 30 to a WiFi relay switching module 28, such as MHCOZY Model No. TYWB 4 Channel Smart WiFi RF Bluetooth Wireless Dry Contact Relay Switch Module. One single pole, single throw relay switch 34 in the module 28 is in the normally closed position and provides a 24 Volt AC power signal 8 to the irrigation system controller 4 to allow the irrigation system controller 4 to function as it normally would to selectively energize the water valves 10 of the various zones of the irrigation system 2. The other (second, third and fourth) single pole, single throw relay switches 36 of the module 28 are in the normally open position. A signal 40 sent by the user's cell phone 32 can open the normally closed first relay switch (also referred to herein as the irrigation interrupt switching circuit) 34 to prevent power 8 from being supplied to the irrigation system controller 4 and thus to the water valves 10 of the various zones of the irrigation system 2, disabling the irrigation system 2. Or, a signal 40 from the user's cell phone 32 may be transmitted to close any one of the normally open second, third or fourth relay switches (also referred to herein as the override switching circuits) 36 of the module 28 (while the normally closed first relay switch 34 is open) to bypass the irrigation system controller 4 and provide energizing power 8 to the water valve 10 of any desired zone of the irrigation system 2. It is also envisioned that the cell phone or other smart device 32 can transmit a Bluetooth™ override signal 30 directly to the switching module 28 without the need for a WiFi transmitter/receiver circuit 38. Thus, incorporating a WiFi relay switching module 28 into the irrigation/animal intrusion system 2 of the present invention will enhance the utilization of the irrigation system 2. A specific watering zone can be activated remotely with the use of a smart device (e.g., a cell phone) 32. Also, a specific irrigation zone can be activated at any time there is a surveillance alert, for example, from a video monitoring home protection system, or a visual observation of animal intrusion. By use of a WiFi connection to the irrigation system 2, the irrigation system 2 can be disabled to permit activities during a scheduled irrigation either at location, or remotely.

The irrigation system 2 of the present invention will now be further described.

In one form of the present invention, an irrigation system 2 having animal deterrent capability may include: an irrigation system controller 4, the irrigation system controller 4 having at least one irrigation switching circuit 6, the at least one irrigation switching circuit 6 having an input on which is provided a water valve energizing voltage 8 and an output, and selectively providing the water valve energizing voltage 8 on the output thereof; at least one water valve 10, the at least one water valve 10 having a water inlet 12 and a water outlet 14, the water inlet 12 being in fluid communication with a source of water, the at least one water valve 10 being electrically coupled to the output of the at least one irrigation switching circuit 6, the at least one water valve 10 allowing water to flow therethrough from the water inlet 12 to and out of the water outlet 14 in response to the water valve energizing voltage 8 being provided on the output of the at least one irrigation switching circuit 6 of the irrigation system controller 4; at least one water sprinkler 16, the at least one water sprinkler 16 being in fluid communication with the water outlet 14 of the at least one water valve 10, the at least one water sprinkler 16 receiving water flowing out of the water outlet 14 of the at least one water valve 10; at least one motion detector 18, the at least one motion detector 18 having a zone of motion detection 20 and transmitting a detection signal 22 in response to motion of an object being detected in the zone of motion detection 20; and a detection signal receiver 24, the detection signal receiver 24 receiving the detection signal 22 transmitted by the at least one motion detector 18, the detection signal receiver 24 having at least one bypass switching circuit 26, the at least one bypass switching circuit 26 having an input on which is provided the water valve energizing voltage 8 and an output, and selectively providing the water valve energizing voltage 8 on the output thereof in response to the detection signal 22 transmitted by the at least one motion detector 18. The at least one water valve 10 is further electrically coupled to the output of the at least one bypass switching circuit 26 of the detection signal receiver 24, the at least one water valve 10 allowing water to flow therethrough from the water inlet 12 to and out of the water outlet 14 in response to the water valve energizing voltage 8 being provided on the output of the at least one bypass switching circuit 26 of the detection signal receiver 24.

In another form of the present invention, an irrigation system 2 as described above may further include: a WiFi (wireless fidelity) relay switching module 28, the WiFi relay switching module 28 receiving an override signal 30 wirelessly transmitted by a remote device 32, the WiFi relay switching module 28 having an irrigation interrupt switching circuit 34 and at least one override switching circuit 36, the irrigation interrupt switching circuit 34 having an input on which is provided the water valve energizing voltage 8 and an output, and selectively providing the water valve energizing voltage 8 on the output thereof, the output of the irrigation interrupt switching circuit 34 of the WiFi relay switching module 28 being electrically coupled to the input of the at least one irrigation switching circuit 6 of the irrigation system controller 4 and selectively providing the water valve energizing voltage 8 to the input of the at least one irrigation switching circuit 6, the at least one override switching circuit 36 of the WiFi relay switching module 28 having an input on which is provided the water valve energizing voltage 8 and an output, and selectively providing the water valve energizing voltage 8 on the output thereof in response to the override signal 30. The at least one water valve 10 is further electrically coupled to the output of the at least one override switching circuit 36 of the WiFi relay switching module 28, the at least one water valve 10 allowing water to flow therethrough from the water inlet 12 to and out of the water outlet 14 in response to the water valve energizing voltage 8 being provided on the output of the at least one override switching circuit 36 of the WiFi relay switching module 28.

In another form of the present invention, an irrigation system 2 as described previously may further include: a WiFi (wireless fidelity) transmitter/receiver 38, the WiFi transmitter/receiver 38 receiving a signal 40 from a remote device 32 and wirelessly transmitting an override signal 30 in response thereto; and a WiFi (wireless fidelity) relay switching module 28, the WiFi relay switching module 28 receiving the override signal 30 wirelessly transmitted by the WiFi transmitter/receiver 38, the WiFi relay switching module 28 having an irrigation interrupt switching circuit 34 and at least one override switching circuit 36, the irrigation interrupt switching circuit 34 having an input on which is provided the water valve energizing voltage 8 and an output, and selectively providing the water valve energizing voltage 8 on the output thereof, the output of the irrigation interrupt switching circuit 34 of the WiFi relay switching module 28 being electrically coupled to the input of the at least one irrigation switching circuit 6 of the irrigation system controller 4 and selectively providing the water valve energizing voltage 8 to the input of the at least one irrigation switching circuit 6, the at least one override switching circuit 36 of the WiFi relay switching module 28 having an input on which is provided the water valve energizing voltage 8 and an output, and selectively providing the water valve energizing voltage 8 on the output thereof in response to the override signal 30. The at least one water valve 10 is further electrically coupled to the output of the at least one override switching circuit 36 of the WiFi relay switching module 28, the at least one water valve 10 allowing water to flow therethrough from the water inlet 12 to and out of the water outlet 14 in response to the water valve energizing voltage 8 being provided on the output of the at least one override switching circuit 36 of the WiFi relay switching module 28.

In the irrigation system 2 described previously, the at least one motion detector 18 may be at least one passive infrared (PIR) motion detector 18.

In the irrigation system 2 described previously, the at least one motion detector 18 may be a wireless motion detector 18, the wireless motion detector 18 wirelessly transmitting the detection signal 22 in response to motion of the object being detected in the zone of motion detection 20 of the at least one motion detector 18. Furthermore, the detection signal receiver 24 may be a wireless detection signal receiver 24, the wireless detection signal receiver 24 receiving the detection signal 22 wirelessly transmitted by the at least one wireless motion detector 18, the wireless detection signal receiver 24 having the at least one bypass switching circuit 26, the at least one bypass switching circuit 26 of the wireless detection signal receiver 24 having the input on which is provided the water valve energizing voltage 8 and the output, and selectively providing the water valve energizing voltage 8 on the output thereof in response to the detection signal 22 wirelessly transmitted by the at least one wireless motion detector 18.

In the irrigation system 2 described previously, the at least one motion detector 18 may be at least one wireless passive infrared (PIR) motion detector 18, the at least one wireless passive infrared (PIR) motion detector 18 wirelessly transmitting the detection signal 22 in response to motion of the object being detected in the zone of motion detection 20 of the at least one wireless passive infrared (PIR) motion detector 18. Furthermore, the detection signal receiver 24 may be a wireless detection signal receiver 24, the wireless detection signal receiver 24 receiving the detection signal 22 wirelessly transmitted by the at least one wireless passive infrared (PIR) motion detector 18, the wireless detection signal receiver 24 having the at least one bypass switching circuit 26, the at least one bypass switching circuit 26 having the input on which is provided the water valve energizing voltage 8 and the output, and selectively providing the water valve energizing voltage 8 on the output thereof in response to the detection signal 22 wirelessly transmitted by the at least one wireless passive infrared (PIR) motion detector 18.

In another form of the present invention, a multi-zone irrigation system 2 having animal deterrent capability may include: a multi-zone irrigation system controller 4, the irrigation system controller 4 having a plurality of irrigation switching circuits 6, each irrigation switching circuit 6 of the plurality of irrigation switching circuits 6 having an input on which is provided a water valve energizing voltage 8 and an output, and selectively providing the water valve energizing voltage 8 on the output thereof; a plurality of water valves 10, each water valve 10 of the plurality of water valves 10 having a water inlet 12 and a water outlet 14, the water inlet 12 of each water valve 10 being in fluid communication with a source of water, each water valve 10 of the plurality of water valves 10 being electrically coupled to the output of a respective irrigation switching circuit 6 of the plurality of irrigation switching circuits 6, each water valve 10 of the plurality of water valves 10 allowing water to flow therethrough from the water inlet 12 to and out of the water outlet 14 in response to the water valve energizing voltage 8 being provided on the output of the respective irrigation switching circuit 6 of the plurality of irrigation switching circuits 6 of the irrigation system controller 4; a plurality of water sprinklers 16, each water sprinkler 16 of the plurality of water sprinklers 16 being in fluid communication with the water outlet 14 of a respective water valve 10 of the plurality of water valves 10 such that each water sprinkler 16 of the plurality of water sprinklers 16 selectively receives water flowing out of the water outlet 14 of the respective water valve 10 of the plurality of water valves 10 with which the water sprinkler 16 is in fluid communication; a plurality of motion detectors 18, each motion detector 18 of the plurality of motion detectors 18 having a zone of motion detection 20 and transmitting a detection signal 22 in response to motion of an object being detected in the zone of motion detection 20; and a detection signal receiver 24, the detection signal receiver 24 receiving the detection signal 22 transmitted by each motion detector 18 of the plurality of motion detectors 18, the detection signal receiver 24 having a plurality of bypass switching circuits 26, each bypass switching circuit 26 of the plurality of bypass switching circuits 26 having an input on which is provided the water valve energizing voltage 8 and an output, and selectively providing the water valve energizing voltage 8 on the output thereof in response to the detection signal 22 transmitted by a respective motion detector 18 of the plurality of motion detectors 18. Each water valve 10 of the plurality of water valves 10 is further electrically coupled to the output of a respective bypass switching circuit 26 of the plurality of bypass switching circuits 26 of the detection signal receiver 24, each water valve 10 of the plurality of water valves 10 allowing water to flow therethrough from the water inlet 12 to and out of the water outlet 14 in response to the water valve energizing voltage 8 being provided on the output of the respective bypass switching circuit 26 of the plurality of bypass switching circuits 26 to which the respective water valve 10 is electrically coupled.

In another form of the present invention, a multi-zone irrigation system 2 as described above may further include: a WiFi (wireless fidelity) relay switching module 28, the WiFi relay switching module 28 receiving an override signal 30 wirelessly transmitted by a remote device 32, the WiFi relay switching module 28 having an irrigation interrupt switching circuit 34 and a plurality of override switching circuits 36, the irrigation interrupt switching circuit 34 having an input on which is provided the water valve energizing voltage 8 and an output, and selectively providing the water valve energizing voltage 8 on the output thereof, the output of the irrigation interrupt switching circuit 34 of the WiFi relay switching module 28 being electrically coupled to the input of each irrigation switching circuit 6 of the plurality of irrigation switching circuits 6 of the irrigation system controller 4 and selectively providing the water valve energizing voltage 8 to the input of each irrigation switching circuit 6 of the plurality of irrigation switching circuits 6, each override switching circuit 36 of the plurality of override switching circuits 36 of the WiFi relay switching module 28 having an input on which is provided the water valve energizing voltage 8 and an output, and selectively providing the water valve energizing voltage 8 on the output thereof in response to the override signal 30. Each water valve 10 of the plurality of water valves 10 is further electrically coupled to the output of a respective override switching circuit 36 of the plurality of override switching circuits 36 of the WiFi relay switching module 28, each water valve 10 of the plurality of water valves 10 allowing water to flow therethrough from the water inlet 12 to and out of the water outlet 14 in response to the water valve energizing voltage 8 being provided on the output of the respective override switching circuit 36 of the plurality of override switching circuits 36 to which the respective water valve 10 is operatively coupled.

In another form of the present invention, a multi-zone irrigation system 2 as described above may further include: a WiFi (wireless fidelity) transmitter/receiver 38, the WiFi transmitter/receiver 38 receiving a signal 40 from a remote device 32 and wirelessly transmitting an override signal 30 in response thereto; and a WiFi (wireless fidelity) relay switching module 28, the WiFi relay switching module 28 receiving the override signal 30 wirelessly transmitted by the WiFi transmitter/receiver 38, the WiFi relay switching module 28 having an irrigation interrupt switching circuit 34 and a plurality of override switching circuits 36, the irrigation interrupt switching circuit 34 having an input on which is provided the water valve energizing voltage 8 and an output, and selectively providing the water valve energizing voltage 8 on the output thereof, the output of the irrigation interrupt switching circuit 34 of the WiFi relay switching module 28 being electrically coupled to the input of each irrigation switching circuit 6 of the plurality of irrigation switching circuits 6 of the irrigation system controller 4 and selectively providing the water valve energizing voltage 8 to the input of each irrigation switching circuit 6 of the plurality of irrigation switching circuits 6, each override switching circuit 36 of the plurality of override switching circuits 36 of the WiFi relay switching module 28 having an input on which is provided the water valve energizing voltage 8 and an output, and selectively providing the water valve energizing voltage 8 on the output thereof in response to the override signal 30. Each water valve 10 of the plurality of water valves 10 is further electrically coupled to the output of a respective override switching circuit 36 of the plurality of override switching circuits 36 of the WiFi relay switching module 28, each water valve 10 of the plurality of water valves 10 allowing water to flow therethrough from the water inlet 12 to and out of the water outlet 14 in response to the water valve energizing voltage 8 being provided on the output of the respective override switching circuit 36 of the plurality of override switching circuits 36 to which the respective water valve 10 is electrically coupled.

In the irrigation system 2 described previously, one or more motion detectors 18 of the plurality of motion detectors 18 may be passive infrared (PIR) motion detectors 18.

In the irrigation system 2 described previously, one or more motion detectors 18 of the plurality of motion detectors 18 may be wireless motion detectors 18, the one or more wireless motion detectors 18 wirelessly transmitting the detection signal 22 in response to motion of the object being detected in the zone of motion detection 20 of a respective one or more wireless motion detectors 18. Furthermore, the detection signal receiver 24 may be a wireless detection signal receiver 24, the wireless detection signal receiver 24 receiving the detection signal 22 wirelessly transmitted by the one or more wireless motion detectors 18 of the plurality of motion detectors 18, the wireless detection signal receiver 24 having each bypass switching circuit 26 of the plurality of bypass switching circuits 26, each bypass switching circuit 26 of the plurality of bypass switching circuits 26 of the wireless detection signal receiver 24 having the input on which is provided the water valve energizing voltage 8 and the output, and selectively providing the water valve energizing voltage 8 on the output thereof in response to the detection signal 22 wirelessly transmitted by a respective one or more wireless motion detectors 18.

In the irrigation system 2 described previously, one or more motion detectors 18 of the plurality of motion detectors 18 may be passive infrared (PIR) motion detectors 18, the one or more wireless passive infrared (PIR) motion detectors 18 wirelessly transmitting the detection signal 22 in response to motion of the object being detected in the zone of motion detection 20 of respective one or more passive infrared (PIR) motion detectors 18. Furthermore, the detection signal receiver 24 may be a wireless detection signal receiver 24, the wireless detection signal receiver 24 receiving the detection signal 22 wirelessly transmitted by the one or more wireless passive infrared (PIR) motion detectors 18 of the plurality of motion detectors 18, the wireless detection signal receiver 24 having each bypass switching circuit 26 of the plurality of bypass switching circuits 26, each bypass switching circuit 26 of the plurality of bypass switching circuits 26 having the input on which is provided the water valve energizing voltage 8 and the output, and selectively providing the water valve energizing voltage 8 on the output thereof in response to the detection signal 22 wirelessly transmitted by respective one or more wireless passive infrared (PIR) motion detectors 18.

Although only three or four water zones are shown in the drawings and described above as being controlled by the irrigation/animal deterrent system of the present invention, it should be understood that the present invention may operate to control any number of zones of an irrigation system, and may include any number of wireless or wired animal detectors.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

What is claimed is:

1. An irrigation system having animal deterrent capability, which comprises:
an irrigation system controller, the irrigation system controller having at least one irrigation switching circuit, the at least one irrigation switching circuit having an input on which is provided a water valve energizing voltage and an output, and selectively providing the water valve energizing voltage on the output thereof;
at least one water valve, the at least one water valve having a water inlet and a water outlet, the water inlet being in fluid communication with a source of water, the at least one water valve being electrically coupled to the output of the at least one irrigation switching circuit, the at least one water valve allowing water to flow therethrough from the water inlet to and out of the water outlet in response to the water valve energizing voltage being provided on the output of the at least one irrigation switching circuit of the irrigation system controller;
at least one water sprinkler, the at least one water sprinkler being in fluid communication with the water outlet of the at least one water valve, the at least one water sprinkler receiving water flowing out of the water outlet of the at least one water valve;
at least one motion detector, the at least one motion detector having a zone of motion detection and transmitting a detection signal in response to motion of an object being detected in the zone of motion detection; and
a detection signal receiver, the detection signal receiver receiving the detection signal transmitted by the at least one motion detector, the detection signal receiver having at least one bypass switching circuit, the at least one bypass switching circuit having an input on which is provided the water valve energizing voltage and an output, and selectively providing the water valve energizing voltage on the output thereof in response to the detection signal transmitted by the at least one motion detector;
wherein the at least one water valve is further electrically coupled to the output of the at least one bypass switching circuit of the detection signal receiver, the at least one water valve allowing water to flow therethrough from the water inlet to and out of the water outlet in response to the water valve energizing voltage being provided on the output of the at least one bypass switching circuit of the detection signal receiver.

2. An irrigation system as defined by claim 1, which further comprises:
a WiFi (wireless fidelity) relay switching module, the WiFi relay switching module receiving an override signal wirelessly transmitted by a remote device, the WiFi relay switching module having an irrigation interrupt switching circuit and at least one override switching circuit, the irrigation interrupt switching circuit having an input on which is provided the water valve energizing voltage and an output, and selectively providing the water valve energizing voltage on the output thereof, the output of the irrigation interrupt switching circuit of the WiFi relay switching module being electrically coupled to the input of the at least one irrigation switching circuit of the irrigation system controller and selectively providing the water valve energizing voltage to the input of the at least one irrigation switching circuit, the at least one override switching circuit of the WiFi relay switching module having an input on which is provided the water valve energizing voltage and an output, and selectively providing the water valve energizing voltage on the output thereof in response to the override signal;
wherein the at least one water valve is further electrically coupled to the output of the at least one override switching circuit of the WiFi relay switching module, the at least one water valve allowing water to flow therethrough from the water inlet to and out of the water outlet in response to the water valve energizing voltage being provided on the output of the at least one override switching circuit of the WiFi relay switching module.

3. An irrigation system as defined by claim 1, which further comprises:
a WiFi (wireless fidelity) transmitter/receiver, the WiFi transmitter/receiver receiving a signal from a remote device and wirelessly transmitting an override signal in response thereto; and
a WiFi (wireless fidelity) relay switching module, the WiFi relay switching module receiving the override signal wirelessly transmitted by the WiFi transmitter/receiver, the WiFi relay switching module having an irrigation interrupt switching circuit and at least one override switching circuit, the irrigation interrupt switching circuit having an input on which is provided the water valve energizing voltage and an output, and selectively providing the water valve energizing voltage on the output thereof, the output of the irrigation interrupt switching circuit of the WiFi relay switching module being electrically coupled to the input of the at least one irrigation switching circuit of the irrigation system controller and selectively providing the water valve energizing voltage to the input of the at least one irrigation switching circuit, the at least one override switching circuit of the WiFi relay switching module having an input on which is provided the water valve energizing voltage and an output, and selectively providing the water valve energizing voltage on the output thereof in response to the override signal;
wherein the at least one water valve is further electrically coupled to the output of the at least one override switching circuit of the WiFi relay switching module, the at least one water valve allowing water to flow therethrough from the water inlet to and out of the water outlet in response to the water valve energizing voltage being provided on the output of the at least one override switching circuit of the WiFi relay switching module.

4. An irrigation system as defined by claim 1, wherein the at least one motion detector is at least one passive infrared (PIR) motion detector.

5. An irrigation system as defined by claim 1, wherein the at least one motion detector is a wireless motion detector, the wireless motion detector wirelessly transmitting the detection signal in response to motion of the object being detected in the zone of motion detection of the at least one motion detector; and
wherein the detection signal receiver is a wireless detection signal receiver, the wireless detection signal receiver receiving the detection signal wirelessly transmitted by the at least one wireless motion detector, the wireless detection signal receiver having the at least one bypass switching circuit, the at least one bypass switching circuit of the wireless detection signal receiver having the input on which is provided the water valve energizing voltage and the output, and selectively providing the water valve energizing voltage on the output thereof in response to the detection signal wirelessly transmitted by the at least one wireless motion detector.

6. An irrigation system as defined by claim 1, wherein the at least one motion detector is at least one wireless passive infrared (PIR) motion detector, the at least one wireless passive infrared (PIR) motion detector wirelessly transmitting the detection signal in response to motion of the object being detected in the zone of motion detection of the at least one wireless passive infrared (PIR) motion detector; and
wherein the detection signal receiver is a wireless detection signal receiver, the wireless detection signal receiver receiving the detection signal wirelessly transmitted by the at least one wireless passive infrared (PIR) motion detector, the wireless detection signal receiver having the at least one bypass switching circuit, the at least one bypass switching circuit having the input on which is provided the water valve energizing voltage and the output, and selectively providing the water valve energizing voltage on the output thereof in response to the detection signal wirelessly transmitted by the at least one wireless passive infrared (PIR) motion detector.

7. A multi-zone irrigation system having animal deterrent capability, which comprises:
a multi-zone irrigation system controller, the irrigation system controller having a plurality of irrigation switching circuits, each irrigation switching circuit of the plurality of irrigation switching circuits having an input on which is provided a water valve energizing voltage and an output, and selectively providing the water valve energizing voltage on the output thereof;
a plurality of water valves, each water valve of the plurality of water valves having a water inlet and a water outlet, the water inlet of each water valve being in fluid communication with a source of water, each water valve of the plurality of water valves being electrically coupled to the output of a respective irrigation switching circuit of the plurality of irrigation switching circuits, each water valve of the plurality of water valves allowing water to flow therethrough from the water inlet to and out of the water outlet in response to the water valve energizing voltage being provided on the output of the respective irrigation switching circuit of the plurality of irrigation switching circuits of the irrigation system controller;
a plurality of water sprinklers, each water sprinkler of the plurality of water sprinklers being in fluid communication with the water outlet of a respective water valve of the plurality of water valves such that each water sprinkler of the plurality of water sprinklers selectively receives water flowing out of the water outlet of the respective water valve of the plurality of water valves with which the water sprinkler is in fluid communication;
a plurality of motion detectors, each motion detector of the plurality of motion detectors having a zone of motion detection and transmitting a detection signal in response to motion of an object being detected in the zone of motion detection; and
a detection signal receiver, the detection signal receiver receiving the detection signal transmitted by each motion detector of the plurality of motion detectors, the detection signal receiver having a plurality of bypass switching circuits, each bypass switching circuit of the plurality of bypass switching circuits having an input on which is provided the water valve energizing voltage and an output, and selectively providing the water valve energizing voltage on the output thereof in response to the detection signal transmitted by a respective motion detector of the plurality of motion detectors;
wherein each water valve of the plurality of water valves is further electrically coupled to the output of a respective bypass switching circuit of the plurality of bypass switching circuits of the detection signal receiver, each water valve of the plurality of water valves allowing water to flow therethrough from the water inlet to and out of the water outlet in response to the water valve energizing voltage being provided on the output of the respective bypass switching circuit of the plurality of bypass switching circuits to which the respective water valve is electrically coupled.

8. A multi-zone irrigation system as defined by claim 7, which further comprises:
a WiFi (wireless fidelity) relay switching module, the WiFi relay switching module receiving an override signal wirelessly transmitted by a remote device, the WiFi relay switching module having an irrigation interrupt switching circuit and a plurality of override switching circuits, the irrigation interrupt switching circuit having an input on which is provided the water valve energizing voltage and an output, and selectively providing the water valve energizing voltage on the output thereof, the output of the irrigation interrupt switching circuit of the WiFi relay switching module being electrically coupled to the input of each irrigation switching circuit of the plurality of irrigation switching circuits of the irrigation system controller and selectively providing the water valve energizing voltage to the input of each irrigation switching circuit of the plurality of irrigation switching circuits, each override switching circuit of the plurality of override switching circuits of the WiFi relay switching module having an input on which is provided the water valve energizing voltage and an output, and selectively providing the water valve energizing voltage on the output thereof in response to the override signal;
wherein each water valve of the plurality of water valves is further electrically coupled to the output of a respective override switching circuit of the plurality of override switching circuits of the WiFi relay switching module, each water valve of the plurality of water valves allowing water to flow therethrough from the water inlet to and out of the water outlet in response to the water valve energizing voltage being provided on the output of the respective override switching circuit of the plurality of override switching circuits to which the respective water valve is operatively coupled.

9. A multi-zone irrigation system as defined by claim 7, which further comprises:
a WiFi (wireless fidelity) transmitter/receiver, the WiFi transmitter/receiver receiving a signal from a remote device and wirelessly transmitting an override signal in response thereto; and
a WiFi (wireless fidelity) relay switching module, the WiFi relay switching module receiving the override signal wirelessly transmitted by the WiFi transmitter/receiver, the WiFi relay switching module having an irrigation interrupt switching circuit and a plurality of override switching circuits, the irrigation interrupt switching circuit having an input on which is provided the water valve energizing voltage and an output, and selectively providing the water valve energizing voltage on the output thereof, the output of the irrigation interrupt switching circuit of the WiFi relay switching module being electrically coupled to the input of each irrigation switching circuit of the plurality of irrigation switching circuits of the irrigation system controller and selectively providing the water valve energizing voltage to the input of each irrigation switching circuit of the plurality of irrigation switching circuits, each override switching circuit of the plurality of override switching circuits of the WiFi relay switching module having an input on which is provided the water valve energizing voltage and an output, and selectively providing the water valve energizing voltage on the output thereof in response to the override signal;
wherein each water valve of the plurality of water valves is further electrically coupled to the output of a respective override switching circuit of the plurality of override switching circuits of the WiFi relay switching module, each water valve of the plurality of water valves allowing water to flow therethrough from the water inlet to and out of the water outlet in response to the water valve energizing voltage being provided on the output of the respective override switching circuit of the plurality of override switching circuits to which the respective water valve is electrically coupled.

10. An irrigation system as defined by claim 7, wherein one or more motion detectors of the plurality of motion detectors are passive infrared (PIR) motion detectors.

11. An irrigation system as defined by claim 7, wherein one or more motion detectors of the plurality of motion detectors are wireless motion detectors, the one or more wireless motion detectors wirelessly transmitting the detection signal in response to motion of the object being detected in the zone of motion detection of a respective one or more wireless motion detectors; and
wherein the detection signal receiver is a wireless detection signal receiver, the wireless detection signal receiver receiving the detection signal wirelessly transmitted by the one or more wireless motion detectors of the plurality of motion detectors, the wireless detection signal receiver having each bypass switching circuit of the plurality of bypass switching circuits, each bypass switching circuit of the plurality of bypass switching circuits of the wireless detection signal receiver having the input on which is provided the water valve energizing voltage and the output, and selectively providing the water valve energizing voltage on the output thereof in response to the detection signal wirelessly transmitted by a respective one or more wireless motion detectors.

12. An irrigation system as defined by claim 7, wherein one or more motion detectors of the plurality of motion detectors are passive infrared (PIR) motion detectors, the one or more wireless passive infrared (PIR) motion detectors wirelessly transmitting the detection signal in response to motion of the object being detected in the zone of motion detection of respective one or more passive infrared (PIR) motion detectors; and
wherein the detection signal receiver is a wireless detection signal receiver, the wireless detection signal receiver receiving the detection signal wirelessly transmitted by the one or more wireless passive infrared (PIR) motion detectors of the plurality of motion detectors, the wireless detection signal receiver having each bypass switching circuit of the plurality of bypass switching circuits, each bypass switching circuit of the plurality of bypass switching circuits having the input on which is provided the water valve energizing voltage and the output, and selectively providing the water valve energizing voltage on the output thereof in response to the detection signal wirelessly transmitted by respective one or more wireless passive infrared (PIR) motion detectors.
